(19) United States
(12) Patent Application Publication
(10) Pub. No.: US 2025/0356258 A1
(43) Pub. Date: Nov. 20, 2025

(54) SELECTIVE SPECULATIVE DECODING

(71) Applicant: Microsoft Technology Licensing, LLC, Redmond, WA (US)

(72) Inventors: Eric Joel HORVITZ, Portola Valley, CA (US); Harsha Prasad NORI, Seattle, WA (US)

(73) Assignee: Microsoft Technology Licensing, LLC, Redmond, WA (US)

(21) Appl. No.: 18/966,057

(22) Filed: Dec. 2, 2024

Related U.S. Application Data
(60) Provisional application No. 63/649,909, filed on May 20, 2024.

(51) Int. Cl. G06N 20/00; G06F 9/451

(52) U.S. Cl. CPC G06N 20/00; G06F 9/451

(57) ABSTRACT

A computing system including one or more processing devices configured to receive a prompt. The one or more processing devices tokenize the prompt to obtain a tokenized prompt including input tokens. Based at least in part on the input tokens, the one or more processing devices compute an output including output tokens over a plurality of autoregressive generation iterations. Computing the output includes, in one or more of the autoregressive generation iterations, based at least in part on a context including the tokenized prompt and a prior output token sequence, executing selective speculative decoding logic to select first and second portions of the output. Computing the output further includes computing the first portion via speculative decoding using one or more drafting models and computing the second portion at a primary machine learning model without speculative decoding. The one or more processing devices transmit the output to an additional computing process.

### CROSS REFERENCE TO RELATED APPLICATIONS

This application claims priority to U.S. Provisional Patent Application Ser. No. 63/649,909, filed May 20, 2024, the entirety of which is hereby incorporated herein by reference for all purposes.

### BACKGROUND

In recent years, machine learning models such as large language models (LLMs) and large multimodal models (LMMs) have included increasing numbers of layers and parameters in order to allow those models to perform more complex tasks. When inferencing is performed at a machine learning model, the total number of computations tends to increase as the number of parameters increases. In addition, the processing time tends to increase as the number of layers increases. Thus, recent increases in model size have resulted in tradeoffs in which larger models with more advanced capabilities also tend to have higher inferencing costs and inferencing latency.

### SUMMARY

According to one aspect of the present disclosure, a computing system is provided, including one or more processing devices configured to receive a prompt. The one or more processing devices are further configured to tokenize the prompt to obtain a tokenized prompt including a plurality of input tokens. Based at least in part on the input tokens, the one or more processing devices are further configured to compute an output including a plurality of output tokens over a plurality of autoregressive generation iterations. Computing the output includes, in one or more of the autoregressive generation iterations, based at least in part on a context including the tokenized prompt and a prior output token sequence, executing selective speculative decoding logic to select a first portion and a second portion of the output. Computing the output further includes computing the first portion of the output via speculative decoding using one or more drafting models. Computing the output further includes computing the second portion of the output at a primary machine learning model without using speculative decoding. The one or more processing devices are further configured to transmit the output to an additional computing process.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system at which one or more processing devices are configured to perform selective speculative decoding, according to one example embodiment.

FIG. 2 schematically shows the computing system when a context is processed at selective speculative decoding logic, according to the example of FIG. 1.

FIG. 3 schematically shows the computing system in an example in which the one or more processing devices are configured to execute a plurality of drafting machine learning models, according to the example of FIG. 1.

FIG. 4 schematically shows the computing system when parallel verification is performed during speculative decoding, according to the example of FIG. 1.

FIG. 5 schematically shows the computing system in an example in which the one or more drafting models include one or more deterministic policies, according to the example of FIG. 1.

FIG. 6A schematically shows the computing system in an example in which the one or more processing devices are further configured to estimate an expected value of performing speculative decoding, according to the example of FIG. 1.

FIG. 6B schematically shows the computing system during training of a complexity classification machine learning model, according to the example of FIG. 6A.

FIG. 7 schematically shows the computing system in an example in which the user inputs a speculative decoding selection user input via a graphical user interface, according to the example of FIG. 1.

FIG. 8A shows a flowchart of a method for use with a computing system to generate a response to a prompt using selectively activated speculative decoding, according to the example of FIG. 1.

FIGS. 8B-8H show additional steps of the method of FIG. 8A that may be performed in some examples.

FIG. 9 shows a schematic view of an example computing environment in which the computing system of FIG. 1 may be instantiated.

### DETAILED DESCRIPTION

In some existing machine learning systems, speculative decoding is used in order to decrease the latency of processing some inputs. In existing approaches to speculative decoding, a smaller machine learning model (in terms of number of layers) is used to generate draft tokens that approximate the outputs of a larger machine learning model. The smaller model has lower latency than the larger machine learning model. Subsequently to computing the draft tokens, the larger machine learning model is used to check the accuracy of the approximation. This verification may be performed on the draft tokens in parallel. Accordingly, the latency of the verification may be reduced compared to autoregressive generation of output tokens at the larger machine learning model, since in autoregressive generation, the output tokens are computed sequentially. Speculative decoding may accordingly reduce inferencing latency in examples in which the smaller model accurately approximates the outputs of the larger model.

In existing approaches, speculative decoding is performed when generating the entire output of the machine learning model. However, during some tasks, the smaller machine learning model may be unable to accurately estimate the outputs of the larger machine learning model. When the estimates of the smaller machine learning model are inaccurate, the larger machine learning model is used to autoregressively generate the output tokens instead. Thus, in such examples, speculative decoding may increase inferencing costs and latency rather than decreasing them, due to the additional computations performed at the smaller model.

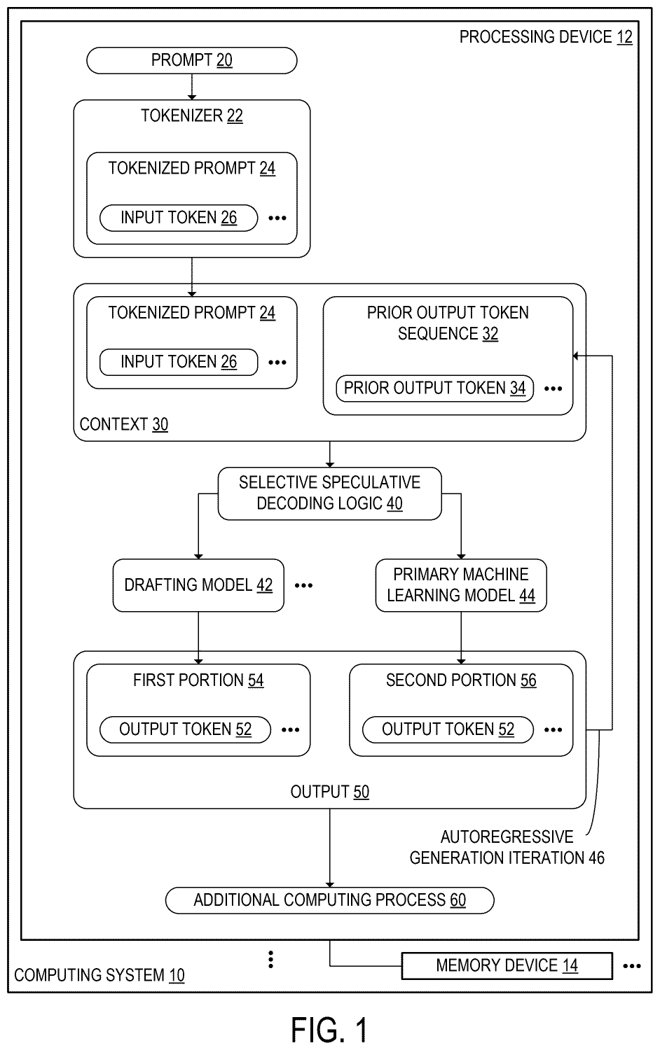

In order to address the above shortcomings of current approaches to speculative decoding, a computing system 10 is provided, as schematically depicted in the example of FIG. 1. Using the computing system 10 of FIG. 1, speculative decoding is selectively applied to a prompt 20 as determined by selective speculative decoding logic 40. The computing system 10 may therefore achieve the decreases in latency associated with speculative decoding while avoiding speculative decoding in scenarios where it is unlikely to produce inferencing speedups.

The computing system 10 includes one or more processing devices 12 and one or more memory devices 14. The one or more processing devices 12 may, for example, include one or more central processing units (CPUs), graphics processing units (GPUs), neural processing units (NPUs), and/or other types of hardware accelerators. The one or more memory devices 14 may, for example, include one or more volatile memory devices and one or more non-volatile storage devices.

In some examples, the one or more processing devices 12 and/or the one or more memory devices 14 may include a plurality of physical components distributed among a plurality of different physical computing devices. For example, the one or more processing devices 12 and/or the one or more memory devices 14 may be included in a networked system of multiple physical computing devices located in a data center. Portions of the functionality of the one or more processing devices 12 and/or the one or more memory devices 14 may additionally or alternatively be performed at one or more client computing devices.

The one or more processing devices 12 are configured to receive a prompt 20. For example, the prompt 20 may be received in natural language form. In some examples, the prompt 20 may be entered by a user at a user interface. In other examples, the prompt 20 may be programmatically generated at another computing process and may be received from that other computing process via an application-programming interface (API).

The one or more processing devices 12 are further configured to execute a tokenizer 22 to compute a tokenized prompt 24 based at least in part on the prompt 20. The tokenized prompt 24 includes a plurality of input tokens 26, which may, for example, indicate words, portions of words, or other characters such as digits or punctuation marks. The tokenizer 22 is accordingly configured to encode the prompt 20 in a form that is usable as input to a machine learning model.

Based at least in part on the input tokens 26, the one or more processing devices 12 are further configured to compute an output 50 including a plurality of output tokens 52. The output 50 is computed over a plurality of autoregressive generation iterations 46 in which corresponding output tokens 52 are generated. As shown in the example of FIG. 1, the tokenized prompt 24 is included in a context 30 along with a prior output token sequence 32 that includes each prior output token 34 generated at a respective previously performed autoregressive generation iteration 46. At each autoregressive generation iteration 46, the current context 30 is used as input.

When generating the output 50, the one or more processing devices 12 are further configured to execute the selective speculative decoding logic 40. The selective speculative decoding logic 40 programmatically determines when speculative decoding is used. At the selective speculative decoding logic 40, the one or more processing devices 12 are configured to select a first portion 54 and a second portion 56 of the output 50 during output generation. For each of the output tokens 52, the one or more processing devices 12 are configured to determine whether that output token 52 is included in the first portion 54 or the second portion 56 of the output 50 prior to generating that output token 52.

The one or more processing devices 12 are further configured to compute the first portion 54 of the output 50 via speculative decoding and compute the second portion 56 of the output 50 without using speculative decoding. The first portion 54 is computed using one or more drafting models 42, whereas the second portion 56 is computed at a primary machine learning model 44. The primary machine learning model 44 may, for example, be an LLM or LMM. The one or more drafting models 42 may also be machine learning models. Additionally or alternatively, as discussed in further detail below, one or more of the drafting models 42 may be deterministic policies.

Subsequently to generating the output 50, the one or more processing devices 12 are further configured to transmit the output 50 to an additional computing process 60. For example, the additional computing process 60 may be a graphical user interface (GUI) at which the one or more processing devices 12 are configured to display the output 50 to a user. As another example, the one or more processing devices 12 may be configured to transmit the output 50 to a compiler at which the output 50 is compiled into assembly-level instructions.

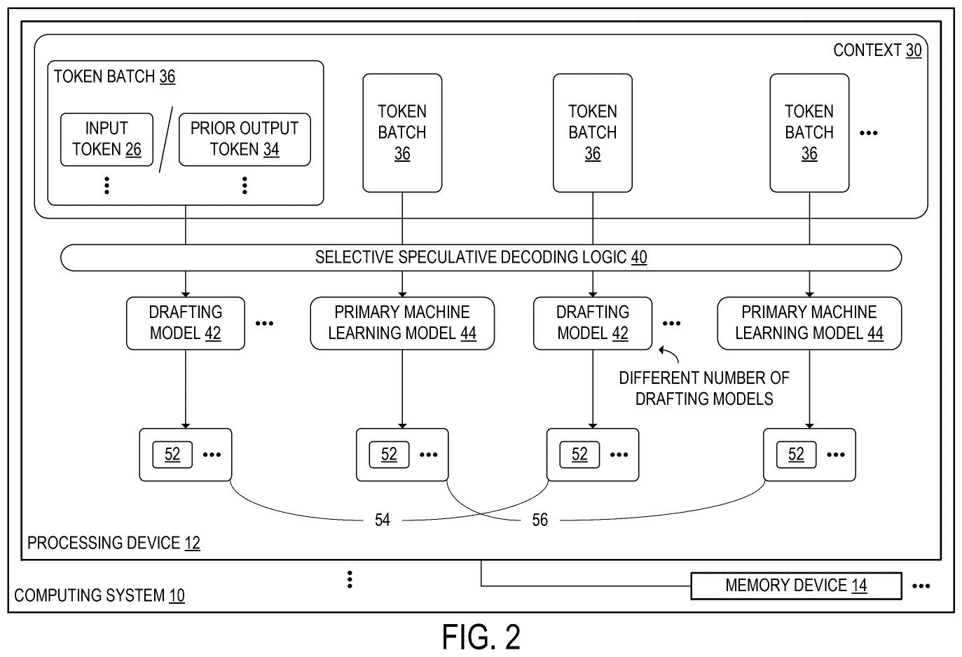

FIG. 2 schematically shows the computing system 10 when the context 30 is processed at the selective speculative decoding logic 40. In the example of FIG. 2, the context 30 includes a plurality of token batches 36, each of which includes one or more tokens. The tokens included in a batch 36 may be the input tokens 26 included in the tokenized prompt 24 or the prior output tokens 34 included in the prior output token sequence 32. The token batches 36 may each include the same number of tokens.

In the example of FIG. 2, the one or more processing devices 12 are configured to execute the selective speculative decoding logic 40 for each of the token batches 36. Accordingly, the one or more processing devices 12 are configured to determine at a predefined interval (in terms of number of tokens) whether to activate or deactivate speculative decoding. In other examples, the one or more processing devices 12 may be configured to execute the selective speculative decoding logic 40 at a predefined interval of some other number of batches, such as every second token batch 36 or every third token batch 36.

As shown in the example of FIG. 2, the first portion 54 and the second portion 56 may include sets of output tokens 52 that are at least partially non-contiguous within the output 50. In the example of FIG. 2, the one or more processing devices 12 begin generating the output tokens 52 using speculative decoding, switch to generating the output tokens 52 at the primary machine learning model 44 without speculative decoding, switch back to using speculative decoding, and switch back to not using speculative decoding. Thus, in the example of FIG. 2, the first portion 54 and the second portion 56 are both non-contiguous.

In some examples, as shown in FIG. 2, the selective speculative decoding logic 40 is further configured to select the number of drafting models 42 used in speculative decoding as well as selecting whether or not speculative decoding is used. In the example of FIG. 2, the one or more processing devices 12 begin generating the output 50 using a first number of drafting models 42. When the one or more processing devices 12 switch back to generating the output 50 via speculative decoding after using the primary machine learning model 44, the one or more processing devices 12 are configured to generate the output tokens 52 using a different number of drafting models 42. The one or more processing devices 12 are therefore configured to compute the first portion 54 at a plurality of drafting models 42, and, at the selective speculative decoding logic 40, during generation of the first portion 54, modify a number of drafting models 42 with which the first portion 54 is computed.

The change in the number of drafting models 42 may, for example, be performed in order to dynamically adjust for changes in the task complexity of token generation. The number of drafting models 42 may, for example, be increased when the selective speculative decoding logic 40 estimates that accurately generating a subsequent portion of the output 50 is likely to utilize a level of model capabilities between that of a single drafting model 42 and that of the primary machine learning model 44. The selective speculative decoding logic 40 may instead decrease the number of drafting models 42 when the estimated complexity of the subsequent portion of the output 50 is estimated as decreasing.

As another example, different drafting models 42 may be specialized for different tasks. In such examples, the selective speculative decoding logic 40 may identify a subject matter area of the context 30 and may select the one or more drafting models 42 according to subject matter areas associated with those one or more drafting models 42. For example, the selective speculative decoding logic 40 may identify a specific programming language in the context 30 and may select a drafting model 42 trained to generate code in that programming language. In some examples, rather than increasing or decreasing the number of drafting models 42 used in speculative decoding, the selective speculative decoding logic 40 may substitute one or more drafting models 42 for one or more other drafting models 42 without changing the overall number.

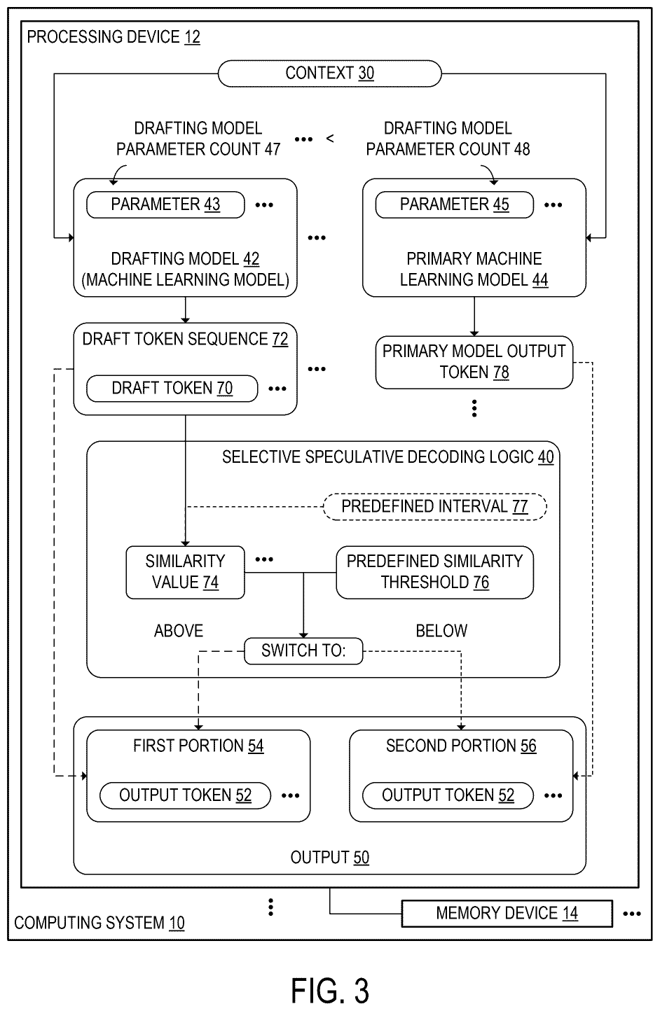

FIG. 3 schematically shows the computing system 10 in an example in which the one or more drafting models 42 include a plurality of drafting machine learning models. The drafting models 42 shown in the example of FIG. 3 each include a plurality of parameters 43. In addition, FIG. 3 shows the primary machine learning model 44, which includes a plurality of parameters 45. The drafting models 42 have respective drafting model parameter counts 47 that are below a primary model parameter count 48 of the primary machine learning model 44. Thus, each of the drafting models 42 may have a lower respective inferencing cost than the primary machine learning model 44.

The one or more processing devices 12 are further configured to compute the first portion 54 at least in part by generating respective draft tokens 70 at the drafting models 42. The draft machine learning models are configured to generate respective draft token sequences 72 of draft tokens 70 as proposed continuations of the context 30. When the second portion 56 is generated, the one or more processing devices 12 are instead configured to compute one or more primary model output tokens 78 at the primary machine learning model 44 based at least in part on the context 30.

During speculative decoding, the one or more processing devices 12 are further configured to compute one or more similarity values 74 between the draft tokens 70. The one or more similarity values 74 may be computed on a token-by-token basis between the draft tokens 70 generated at respective drafting models 42. Alternatively, the similarity values 74 may be computed between the draft token sequences 72. The similarity values 74 may, for example, be cosine similarity values, or alternatively may be computed using some other similarity function.

In the example of FIG. 3, the one or more processing devices 12 are further configured to determine that the one or more similarity values 74 are below a predefined similarity threshold 76. In response to determining that the one or more similarity values 74 are below the predefined similarity threshold 76, the one or more processing devices 12 are further configured to switch from generating the output tokens 52 at the plurality of drafting models 42 to generating the output tokens 52 at the primary machine learning model 44. The selective speculative decoding logic 40 accordingly deactivates speculative decoding when the one or more processing devices 12 determine that the predictions of the drafting models 42 diverge from each other, as indicated by the similarity values 74 dropping below the predefined similarity threshold 76. In some examples in which a plurality of similarity values 74 are computed at the selective speculative decoding logic 40, the one or more processing devices 12 may be configured to deactivate speculative decoding in response to determining that any of the similarity values 74 are below the predefined similarity threshold 76. In other examples, the one or more processing devices 12 may be configured to deactivate speculative decoding in response to determining that all the similarity values 74, or some other number of the similarity values 74 (e.g., more than half) are below the predefined similarity threshold 76.

In some examples, during computation of the second portion 56, the one or more processing devices 12 are configured to execute the selective speculative decoding logic 40 to determine whether to activate speculative decoding. The one or more processing devices 12 may, in such examples, be configured to generate draft token sequences 72 at the drafting models 42 at some predefined interval 77 (e.g., every five token batches 36). The one or more processing devices 12 may be further configured to compute the similarity values 74 for those draft token sequences 72 and determine whether the similarity values 74 are above the predefined similarity threshold 76. In response to determining that the similarity value 74 is above the predefined similarity threshold 76, the one or more processing devices 12 may be further configured to reactivate speculative decoding. The one or more processing devices 12 may accordingly be configured to check, at the predefined interval 77, whether to switch to using speculative decoding.

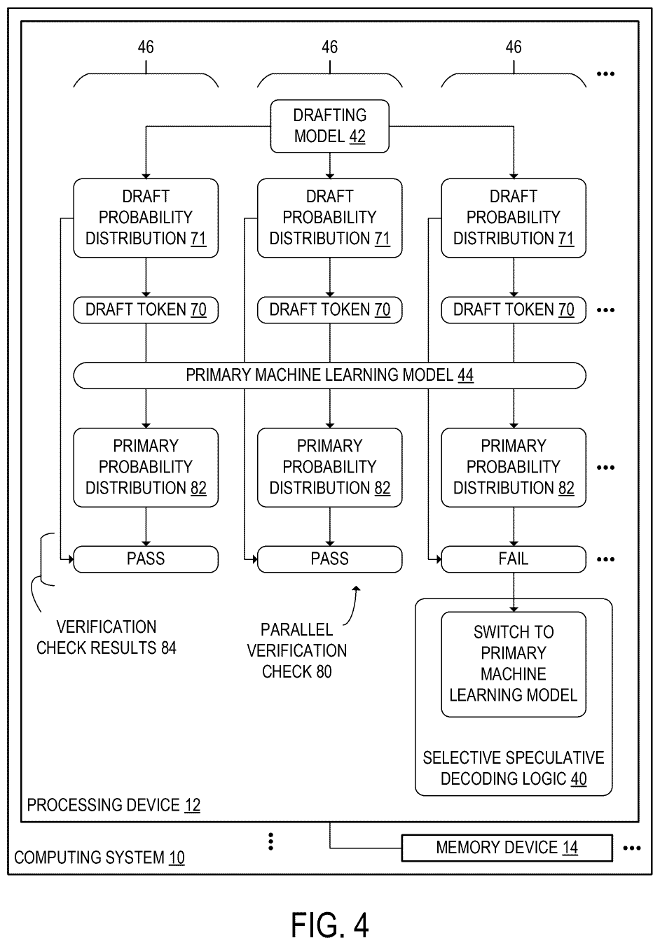

FIG. 4 schematically shows the computing system 10 when parallel verification is performed during speculative decoding. In the example of FIG. 4, as in the example of FIG. 3, the one or more processing devices 12 are configured to compute the first portion 54 at least in part by generating respective draft tokens 70 at the drafting models 42. FIG. 4 shows the computation of respective draft tokens 70 at a drafting model 42 during three autoregressive generation iterations 46. During those autoregressive generation iterations 46, the draft tokens 70 are sampled from draft probability distributions 71 computed at the drafting model 42.

At the primary machine learning model 44, the one or more processing devices 12 are further configured to perform a parallel verification check 80 on the draft tokens 70. During the parallel verification check 80, the one or more processing devices 12 are configured to generate respective primary probability distributions 82 associated with the draft tokens 70 at the primary machine learning model 44. In addition, during the parallel verification check 80, the one or more processing devices 12 are further configured to compare the primary probability distributions 82 to the draft probability distributions 71 and/or the draft tokens 70. The one or more processing devices 12 may, for example, be configured to perform greedy decoding, approximate greedy decoding, or nucleus sampling. In examples in which a plurality of draft token sequences 72 are generated, the one or more processing devices 12 may be configured to perform token tree verification when performing the parallel verification check 80.

In the example of FIG. 4, the one or more processing devices 12 are further configured to determine that one or more of the draft tokens 70 fail the parallel verification check 80. In response to determining that the one or more draft tokens 70 fail the parallel verification check 80, the one or more processing devices 12 are further configured to deactivate speculative decoding and switch from generating the output tokens 52 at the plurality of drafting models 42 to generating the output tokens 52 at the primary machine learning model 44. Rather than using the primary machine learning model 44 to replace failed draft tokens 70 on the individual level, as in conventional approaches to parallel verification, the one or more processing devices 12 may be configured to deactivate speculative decoding in the computation of one or more subsequent output tokens 52, thereby avoiding costs associated with executing the drafting models 42.

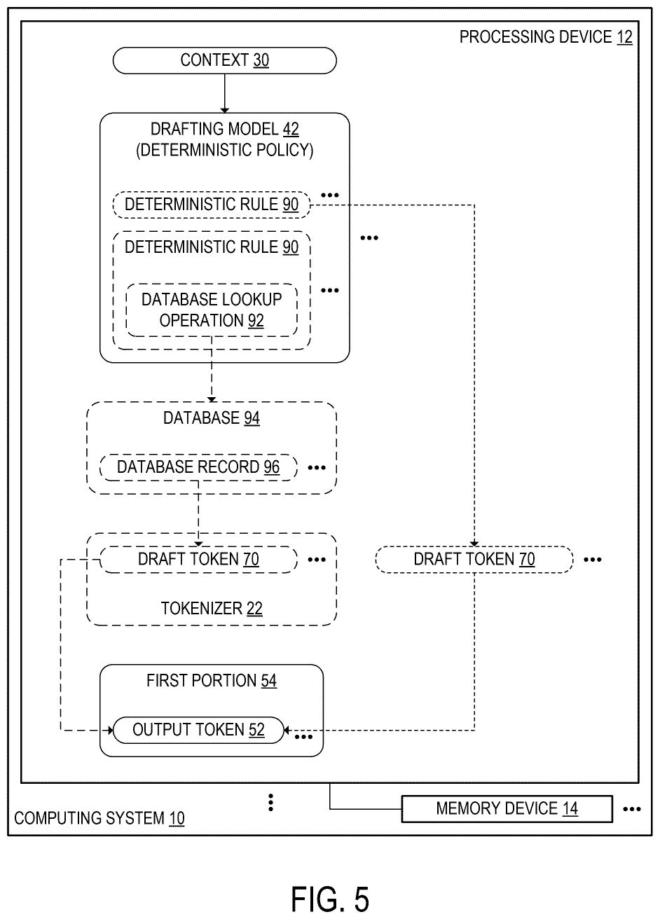

In some examples, as shown in FIG. 5, the one or more drafting models 42 may include one or more deterministic policies additionally or alternatively to one or more drafting machine learning models. These deterministic policies each include one or more deterministic rules 90 that specify the respective draft tokens 70 generated when different types of input included in the context 30 are received. In some examples, the one or more deterministic rules 90 may output one or more draft tokens 70 directly.

In other examples, the one or more processing devices 12 are configured to execute the one or more deterministic policies to compute the first portion 54 at least in part by performing a database lookup operation 92. When the database lookup operation 92 is performed, the one or more processing devices 12 are configured to retrieve one or more database records 96 from a database 94. In some examples, the one or more database records 96 may be the one or more draft tokens 70. In other examples, the one or more processing devices 12 may be further configured to post-process the one or more database records 96, such as tokenizing the one or more database records 96 at the tokenizer 22 to obtain the one or more draft tokens 70. Parallel verification may then be performed on the draft tokens 70 to generate the first portion 54, as discussed above.

By retrieving the one or more database records 96 from the database 94 and using those database records 96 to compute the draft tokens 70, the one or more processing devices 12 are configured to leverage data sources from outside the primary machine learning model 44 to generate the first portion 54 of the output 50 while still using the primary machine learning model 44 to check the draft tokens 70 for consistency with the context 30. The database lookup operation 92 may, for example, be used when the selective speculative decoding logic 40 identifies a predefined pattern in the context 30 that has a deterministic completion. In such examples, by performing the database lookup operation 92, the one or more processing devices 12 may avoid incurring costs associated with executing one or more drafting machine learning models.

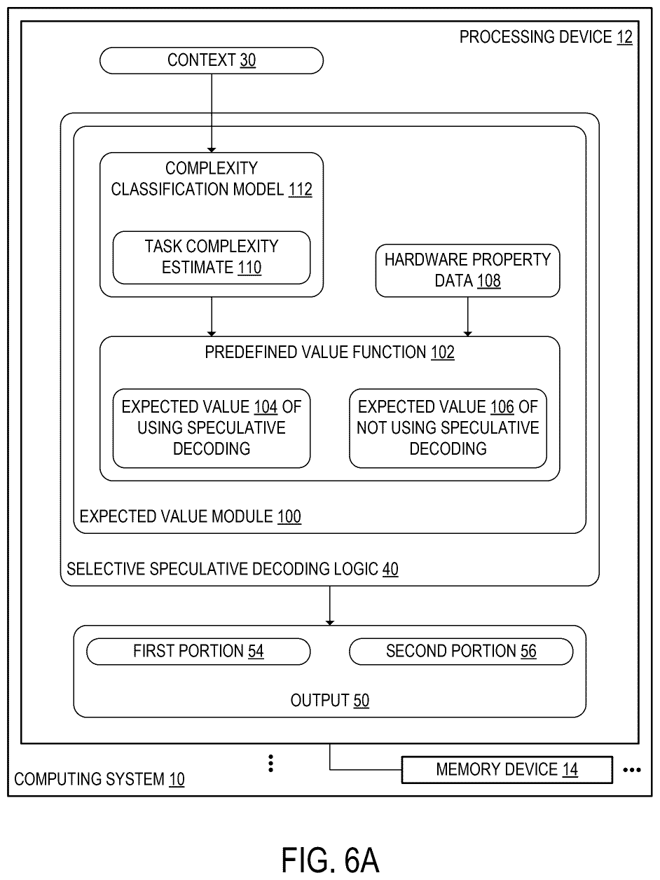

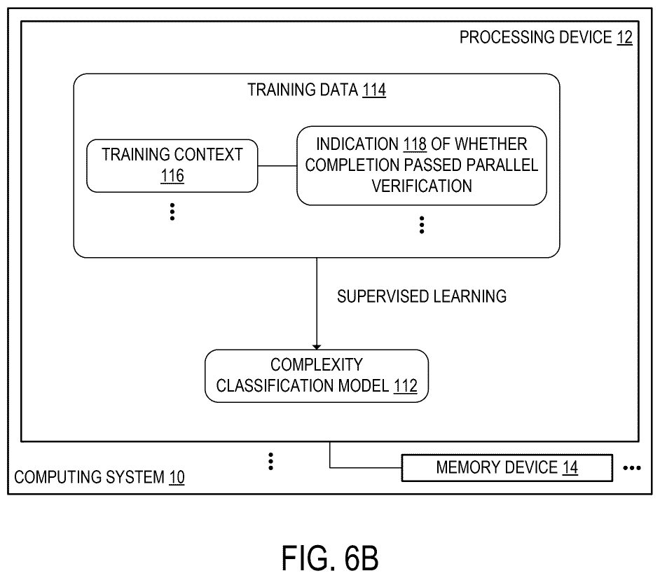

FIG. 6A schematically shows the computing system 10 in an example in which, at the selective speculative decoding logic 40, the one or more processing devices 12 are further configured to estimate an expected value 104 of performing speculative decoding. The one or more processing devices 12 are further configured to determine whether to use speculative decoding based at least in part on the expected value 104. The expected value 104 is computed at an expected value module 100 that is included in the selective speculative decoding logic 40 and includes a predefined value function 102. In addition, the one or more processing devices 12 may be configured to compute an expected value 106 of not using speculative decoding and instead computing the output tokens 52 at the primary machine learning model 44. By determining whether the expected value 104 or the expected value 106 is higher, the selective speculative decoding logic 40 may determine whether to use speculative decoding.

The predefined value function 102 may encode an estimate of computing resource utilization when generating the output 50. For example, weighted estimates of latency, processing device usage, memory bandwidth usage, and/or energy consumption may be encoded in the predefined value function 102. In some examples, the predefined value function 102 specifies an expected value of information (EVI) associated with the draft tokens 70.

In some examples, the one or more processing devices 12 are configured to use hardware property data 108 of the computing system 10 as inputs to the predefined value function 102. The hardware property data 108 may indicate properties of the one or more processing devices 12 and/or the one or more memory devices 14 that are used to execute the primary machine learning model 44 and the one or more drafting models 42. Network topology data of the hardware devices included in the computing system 10 may be indicated in the hardware property data 108 in some examples. Thus, at the predefined value function 102, the one or more processing devices 12 may be configured to use the hardware property data 108 to compute quantities such as latency and processing device usage.

At the expected value module 100, the one or more processing devices 12 may be further configured to compute a task complexity estimate 110 based at least in part on the context 30. The task complexity estimate 110 may be a classification that estimates, based at least in part on the context 30, whether speculative decoding will produce a continuation of the context 30 that passes parallel verification. The one or more processing devices 12 may be configured to compute the task complexity estimate 110 at a complexity classification model 112, which may be a deterministic model or a machine learning model.

FIG. 6B shows an example of the training of the complexity classification model 112 when the complexity classification model 112 is a machine learning model. As shown in the example of FIG. 6B, the complexity classification model 112 may be trained via supervised learning with training data 114 that includes training contexts 116, along with indications 118 of whether the completions of those training contexts 116 computed at the drafting models 42 passed parallel verification. The complexity classification model 112 is thereby trained to classify contexts 30 according to whether parallel verification is likely to succeed. The complexity classification model 112 may be a lightweight machine learning model that has lower latency and processing costs (e.g., in terms of processing device usage and energy usage) than the primary machine learning model 44 and the one or more drafting models 42. Thus, executing the complexity classification model 112 when computing the expected value 104 of using speculative decoding may result in processing cost savings.

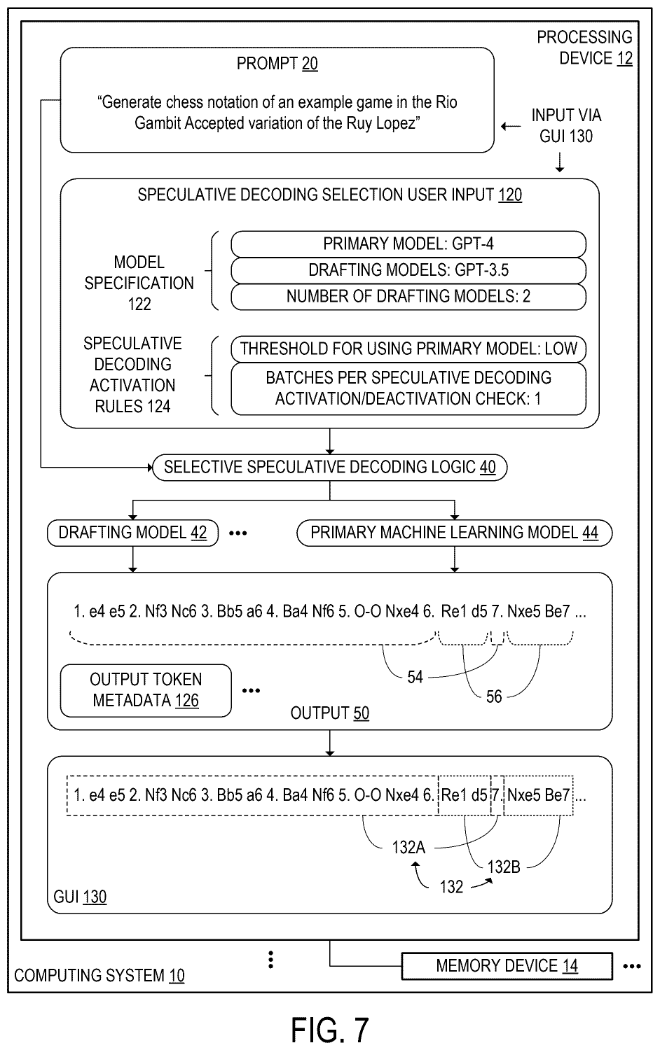

In some examples, at least a portion of the selective speculative decoding logic 40 may be specified by user input. FIG. 7 schematically shows the computing system 10 in an example in which the user inputs a speculative decoding selection user input 120 via a GUI 130. The user may also use the GUI 130 to input the prompt 20, which, in the example of FIG. 7, is “Generate chess notation of an example game in the Rio Gambit Accepted variation of the Ruy Lopez.”

The speculative decoding selection user input 120 entered in the example of FIG. 7 includes a model specification 122 and speculative decoding activation rules 124. In the model specification 122, the user specifies what models are used as the primary machine learning model 44 and the one or more drafting models 42, as well as the number of drafting models 42. In the example of FIG. 7, the user instructs the computing system 10 to use GPT-4 as the primary machine learning model 44, use GPT-3.5 as the drafting models 42, and to use two drafting models 42 when performing speculative decoding.

The speculative decoding selection user input 120 indicates one or more speculative decoding activation rules 124 associated with the prompt 20. At the selective speculative decoding logic 40, the one or more processing devices 12 are further configured to select the first portion 54 and the second portion 56 at least in part by applying the one or more speculative decoding activation rules 124. In the speculative decoding activation rules 124, the user instructs the selective speculative decoding logic 40 to have a low threshold for switching to using the primary machine learning model 44 without speculative decoding. This low threshold may correspond to a high value of the predefined similarity threshold 76 below which the one or more processing devices 12 are configured to deactivate speculative decoding, as discussed above with reference to FIG. 3. In other examples, the user may directly specify the predefined similarity threshold 76 in the speculative decoding activation rules 124. The speculative decoding activation rules 124, in the example of FIG. 7, further include instructions to check whether to activate or deactivate speculative decoding at each token batch 36.

In some examples, rather than selecting predefined options when specifying the selective decoding activation rules 124, the user may input custom-written code that defines at least a portion of the selective speculative decoding logic 40. For example, the user may write code that specifies a predefined value function 102 and may input that code into the selective speculative decoding logic 40.

In the example of FIG. 7, when the output 50 is generated, the one or more processing devices 12 are further configured to assign respective output token metadata 126 to the output tokens 52. The output token metadata 126 of each output token 52 indicates the primary machine learning model 44 or the one or more drafting models 42 with which that output token 52 was generated. Thus, the output token metadata 126 indicates the first portion 54 and the second portion 56 of the output 50.

The output 50 shown in the example of FIG. 7 begins with the output token sequence “1. e4 e5 2. Nf3 Nc6 3. Bb5 a6 4. Ba4 Nf6 5. O-O Nxe4 6.” This sequence is generated at the drafting models 42 as part of the first portion 54 of the output 50. The above output token sequence occurs numerous times in the training data of the drafting models 42 and the primary machine learning model 44 as the sequence of moves that defines the Rio Gambit Accepted variation of the Ruy Lopez. Thus, the above output token sequence is generated accurately by the drafting models 42 via speculative decoding.

The output 50 continues with the output token sequence “Rel d5,” which is instead generated at the primary machine learning model 44 as part of the second portion 56. When generating these output tokens 52, the one or more processing devices 12 have left the portion of the output 50 that is predicted accurately by the drafting models 42, as indicated, for example, by the similarity value 74 dropping below the predefined similarity threshold 76. The one or more processing devices 12 are instead configured to compute these tokens at the primary machine learning model 44. Thus, the one or more processing devices 12 utilize the higher capabilities of the primary machine learning model 44 in order to produce output tokens 52 that are more likely to represent valid and realistic chess moves.

The one or more processing devices 12, in the example of FIG. 7, are further configured to reactivate speculative decoding to compute the token “7.” Since “7.” and the other turn number indicators follow a consistent pattern, the turn number indicators are accurately generated with speculative decoding. Following this token, the one or more processing devices 12 are further configured to compute “Nxe5 Be7” at the primary machine learning model 44. Thus, the output 50 interleaves output tokens 52 computed at the drafting models 42 and output tokens 52 computed at the primary machine learning model 44.

The one or more processing devices 12 are further configured to present the output 50 to the user at the GUI 130 along with a graphical representation 132 of the output token metadata 126. The graphical representation 132, in the example of FIG. 7, includes highlighting applied to the first portion 54 and the second portion 56 such that the first portion 54 and the second portion 56 are visually distinguishable. For example, the first portion 54 and the second portion 56 may be highlighted in different colors. Text labels may additionally or alternatively be included in the graphical representation 132. In examples in which the set of drafting models 42 changes over the course of generating the output 50, as a result of adding, removing, or substituting one or more of the drafting models 42, these changes in the set of drafting models 42 may also be graphically represented at the GUI 130, such as with different colors of highlighting assigned to regions of the first portion 54 that are generated at different sets of one or more drafting models 42. The graphical representation 132 accordingly indicates the provenances of the different portions of the output 50.

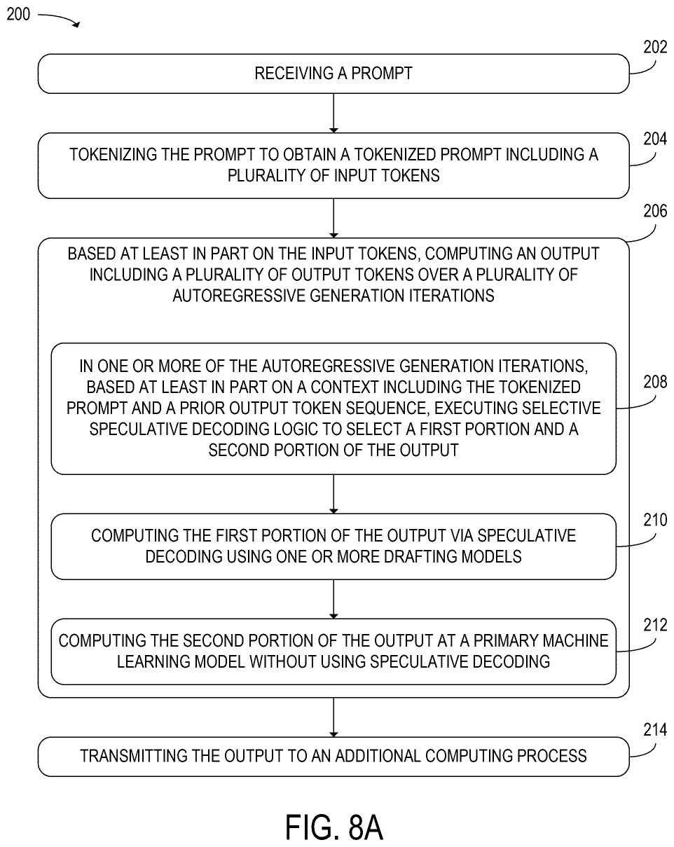

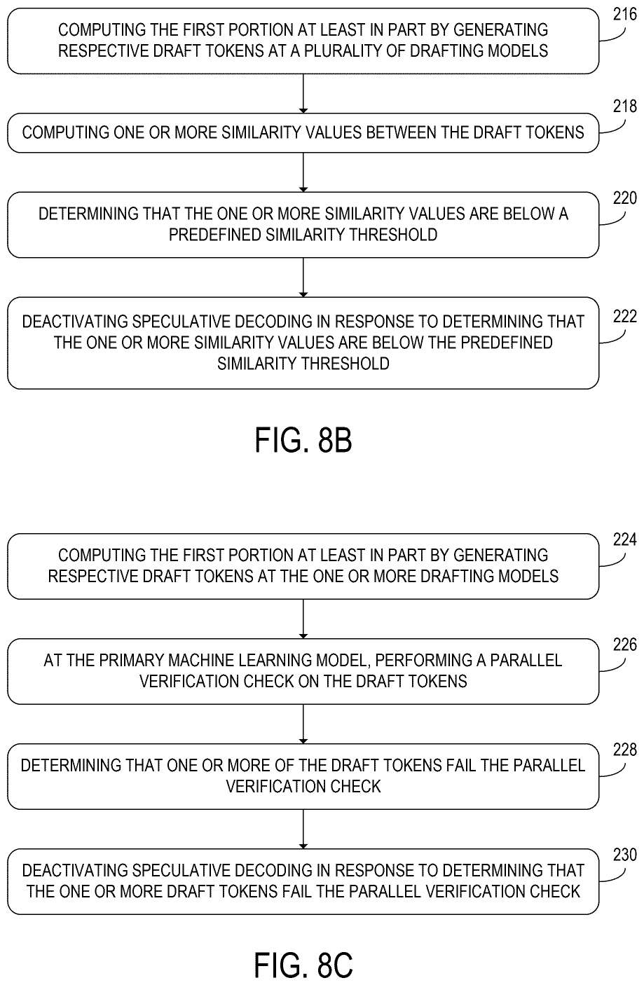

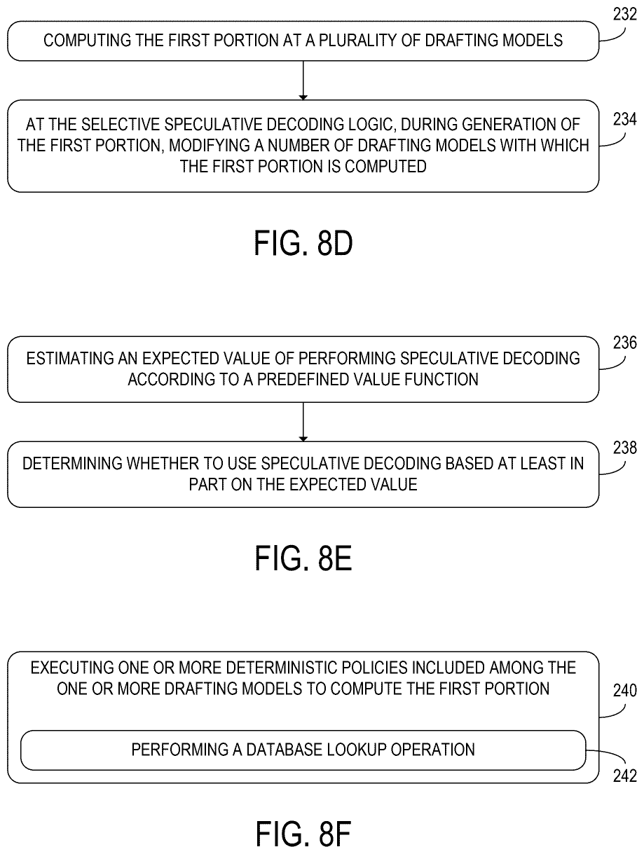

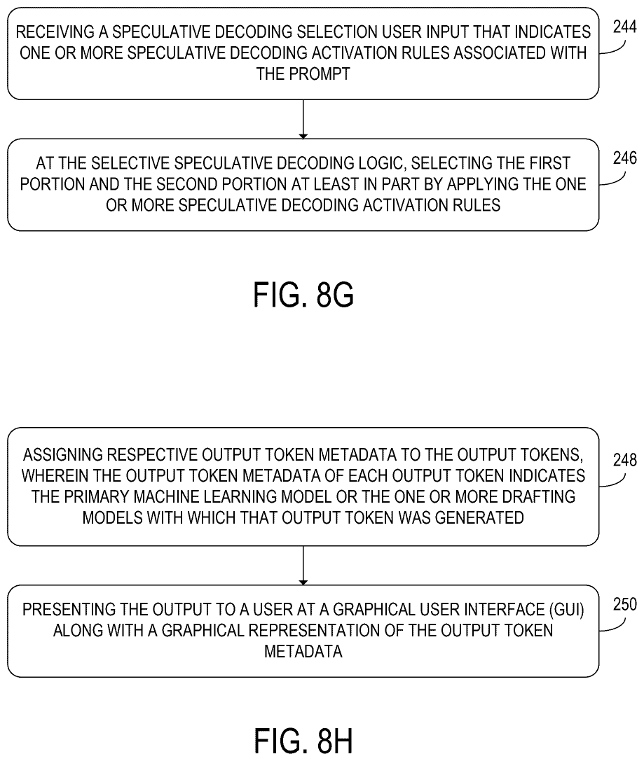

FIG. 8A shows a flowchart of a method 200 for use with a computing system to generate a response to a prompt using selectively activated speculative decoding. At step 202, the method 200 includes receiving a prompt. The prompt may, for example, be in the form of natural language. At step 204, the method 200 further includes tokenizing the prompt to obtain a tokenized prompt including a plurality of input tokens.

At step 206, based at least in part on the input tokens, the method 200 further includes computing an output that includes a plurality of output tokens. The output is computed over a plurality of autoregressive generation iterations in which, at each autoregressive generation iteration, an output token is computed and is appended to a context that includes the tokenized input and a prior output token sequence.

Steps 208, 210, and 212 are performed during step 206 when computing the output. At step 208, the method 200 further includes executing selective speculative decoding logic to select a first portion and a second portion of the output. The selective speculative decoding logic is executed in one or more of the autoregressive generation iterations, based at least in part on the context that includes the tokenized prompt and the prior output token sequence. For each output token, the selective speculative decoding logic determines whether that output token is to be included in the first portion or the second portion before that output token is generated. The first portion and the second portion may, for example, be selected on a per-batch basis for each of a plurality of token batches included in the context.

At step 210, step 206 further includes computing the first portion of the output via speculative decoding using one or more drafting models. For example, the one or more drafting models may include a plurality of drafting machine learning models. At step 212, step 206 further includes computing the second portion of the output at a primary machine learning model without using speculative decoding. In examples in which the one or more drafting models include a plurality of drafting machine learning models, the drafting models may have respective drafting model parameter counts below a primary model parameter count of the primary machine learning model. Thus, processing costs associated with computing the output tokens at the drafting models may be lower than those associated with computing the output tokens at the primary machine learning model.

At step 214, the method 200 further includes transmitting the output to an additional computing process. For example, the additional computing process may be a GUI or a compiler.

FIGS. 8B-8H show additional steps of the method 200 that may be performed in some examples. FIG. 8B shows steps that may be performed when executing the selective speculative decoding logic and computing the output at step 206. At step 216, the method 200 may further include computing the first portion at least in part by generating respective draft tokens at a plurality of drafting models. The drafting models at which the draft tokens are generated may be drafting machine learning models.

At step 218, the method 200 may further include computing one or more similarity values between the draft tokens. For example, the similarity values may be cosine similarity values. The similarity values may be computed between individual tokens or token sequences. In some examples, the similarity values are computed between output probability distributions of the drafting models that are sampled to compute the draft tokens, rather than between the draft tokens themselves.

At step 220, the method 200 may further include determining that the one or more similarity values are below a predefined similarity threshold. At step 222, the method 200 may further include deactivating speculative decoding in response to determining that the one or more similarity values are below the predefined similarity threshold. In some examples, when generating the second portion, the selective speculative decoding logic also periodically checks whether draft tokens computed at the drafting models exceed the predefined similarity value, and if so, activates speculative decoding.

FIG. 8C shows additional steps that may be performed during step 206 in some examples. At step 224, the method 200 may further include computing the first portion at least in part by generating respective draft tokens at the one or more drafting models. At step 226, the method 200 may further include performing a parallel verification check on the draft tokens at the primary machine learning model. For example, the parallel verification check may be performed via greedy decoding, approximate greedy decoding, or nucleus sampling.

At step 228, the method 200 may further include determining that one or more of the draft tokens fail the parallel verification check. At step 230, the method 200 may further include deactivating speculative decoding in response to determining that the one or more draft tokens fail the parallel verification check. In examples in which the selective speculative decoding logic checks whether to reactivate speculative decoding at a predefined interval, that check may include performing parallel verification and reactivating speculative decoding if the draft tokens pass the parallel verification check.

FIG. 8D shows additional steps that may be performed during step 206 in some examples. At step 232, the method 200 may further include computing the first portion at a plurality of drafting models. At step 234, the method 200 may further include, at the selective speculative decoding logic, during generation of the first portion, modifying a number of drafting models with which the first portion is computed. In some examples, the selective speculative decoding logic may instead substitute one or more of the drafting models without changing the total number of drafting models. The set of drafting models used in speculative decoding may, for example, be modified to account for differences in task complexity and/or subject matter area between different parts of the output.

FIG. 8E shows steps of the method 200 that may be performed in some examples at the selective speculative decoding logic during step 208. At step 236, the method 200 may further include estimating an expected value of performing speculative decoding according to a predefined value function. The expected value of performing speculative decoding may be an expected value of information provided by the draft tokens. The expected value may, for example, encode an approximation of latency, energy consumption, usage of one or more processing devices, and/or usage of one or more memory devices. In some examples, the expected value is computed based at least in part on hardware property data of the computing system. A task complexity estimate computed based at least in part on the context may also be used in the computation of the expected value.

At step 238, the method 200 may further include determining whether to use speculative decoding based at least in part on the expected value. For example, the selective speculative decoding logic may also compute an expected value of not using speculative decoding and may determine whether to use speculative decoding according to which expected value is higher.

FIG. 8F shows additional steps of the method 200 that may be performed in some examples when computing the first portion of the output at step 210. At step 240, the method 200 may further include executing one or more deterministic policies included among the one or more drafting models. The deterministic policies may be included in the set of drafting models along with or instead of one or more drafting machine learning models. Step 240 may include, at step 242, performing a database lookup operation when executing the one or more deterministic policies. The database record retrieved via the database lookup operation may be a draft token or sequence of draft tokens. Alternatively, the database record may be post-processed to obtain the one or more draft tokens.

FIG. 8G shows additional steps of the method 200 that may be performed in some examples. At step 244, the method 200 may further include receiving a speculative decoding selection user input that indicates one or more speculative decoding activation rules associated with the prompt. For example, the user may input the speculative decoding selection user input as code that defines at least a portion of the selective speculative decoding logic. A model selection of the primary machine learning model and/or the one or more drafting models may also be included in the speculative decoding selection user input. At step 246, the method 200 may further include, at the selective speculative decoding logic, selecting the first portion and the second portion at least in part by applying the one or more speculative decoding activation rules. In examples in which a model selection is included in the speculative decoding selection user input, the first portion and the second portion may be generated with the selected models.

FIG. 8H shows additional steps of the method 200 that may be performed when the output is generated and transmitted to the additional computing process. At step 248, the method 200 may further include assigning respective output token metadata to the output tokens. The output token metadata of each output token may indicate the primary machine learning model or the one or more drafting models with which that output token was generated. At step 250, the method 200 may further include presenting the output to a user at a GUI along with a graphical representation of the output token metadata. For example, the output token metadata may be represented via highlighting or via textual labels.

Using the systems and methods discussed above, a machine learning model output is generated in a manner that uses speculative decoding to reduce latency. However, rather than using speculative decoding during the entire process of generating the output, speculative decoding is selectively activated in order to save computational costs associated with some using speculative decoding for a portion of the output at which draft tokens would be inaccurate. The selective speculative decoding logic may be specified in a flexible manner that is adjustable for different use case scenarios with different properties.

The methods and processes described herein are tied to a computing system of one or more computing devices. In particular, such methods and processes can be implemented as a computer-application program or service, an application-programming interface (API), a library, and/or other computer-program product.

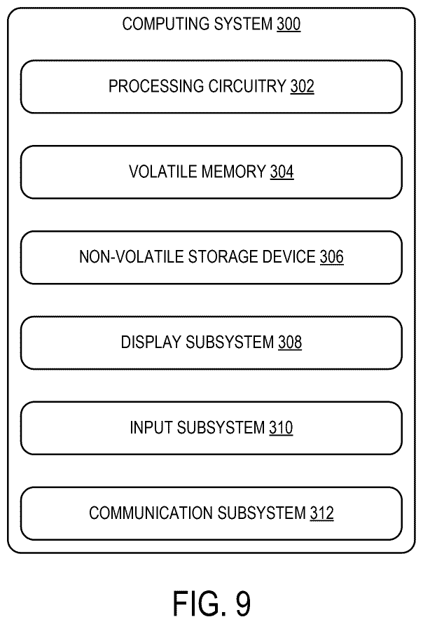

FIG. 9 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 9.

Processing circuitry 302 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions.

Processors of the processing circuitry 302 may be single-core or multi-core, and the instructions executed thereon may be configured for sequential, parallel, and/or distributed processing. Individual components of the processing circuitry 302 optionally may be distributed among two or more separate devices, which may be remotely located and/or configured for coordinated processing. For example, aspects of the computing system 300 disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device 306, and thus transform the state of the non-volatile storage device 306, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem 312 may be configured for communication via a wired or wireless local- or wide-area network, broadband cellular network, etc. In some embodiments, the communication subsystem 312 may allow computing system 300 to send and/or receive messages to and/or from other devices via a network such as the Internet.

The following paragraphs discuss several aspects of the present disclosure. According to one aspect of the present disclosure, a computing system is provided, including one or more processing devices configured to receive a prompt. The one or more processing devices are further configured to tokenize the prompt to obtain a tokenized prompt including a plurality of input tokens. Based at least in part on the input tokens, the one or more processing devices are further configured to compute an output including a plurality of output tokens over a plurality of autoregressive generation iterations. Computing the output includes, in one or more of the autoregressive generation iterations, based at least in part on a context including the tokenized prompt and a prior output token sequence, executing selective speculative decoding logic to select a first portion and a second portion of the output. Computing the output further includes computing the first portion of the output via speculative decoding using one or more drafting models. Computing the output further includes computing the second portion of the output at a primary machine learning model without using speculative decoding. The one or more processing devices are further configured to transmit the output to an additional computing process. The above features may have the technical effect of generating the output in a manner that uses speculative decoding to reduce latency, while also avoiding computational costs associated with executing the drafting models when generating portions of the output at which the draft tokens are likely to be inaccurate.

According to this aspect, the one or more drafting models may include a plurality of drafting machine learning models that have respective drafting model parameter counts below a primary model parameter count of the primary machine learning model. The above features may have the technical effect of computing the draft tokens with lower latency and costs relative to computing output tokens at the primary machine learning model.

According to this aspect, the one or more processing devices may be further configured to compute the first portion at least in part by generating respective draft tokens at a plurality of drafting models. The one or more processing devices may be further configured to compute one or more similarity values between the draft tokens. The one or more processing devices may be further configured to determine that the one or more similarity values are below a predefined similarity threshold. The one or more processing devices may be further configured to deactivate speculative decoding in response to determining that the one or more similarity values are below the predefined similarity threshold. The above features may have the technical effect of deactivating speculative decoding when the outputs of the drafting models disagree with each other.

According to this aspect, the one or more processing devices may be further configured to compute the first portion at least in part by generating respective draft tokens at the one or more drafting models. At the primary machine learning model, the one or more processing devices may be further configured to perform a parallel verification check on the draft tokens. The one or more processing devices may be further configured to determine that one or more of the draft tokens fail the parallel verification check. The one or more processing devices may be further configured to deactivate speculative decoding in response to determining that the one or more draft tokens fail the parallel verification check. The above features may have the technical effect of checking the accuracy of the draft tokens in a low-latency manner and deactivating speculative decoding when the draft tokens disagree with the outputs of the primary machine learning model.

According to this aspect, at the selective speculative decoding logic, the one or more processing devices may be further configured to estimate an expected value of performing speculative decoding according to a predefined value function. The one or more processing devices may be further configured to determine whether to use speculative decoding based at least in part on the expected value. The above features may have the technical effect of selectively activating speculative decoding when, according to the predefined value function, the expected value of using speculative decoding is positive.

According to this aspect, the context may include a plurality of token batches. The one or more processing devices may be configured to execute the selective speculative decoding logic for each of the token batches. The above features may have the technical effect of determining at a predefined interval whether to activate or deactivate speculative decoding.

According to this aspect, the one or more drafting models include one or more deterministic policies. The one or more processing devices may be configured to execute the one or more deterministic policies to compute the first portion at least in part by performing a database lookup operation. The above features may have the technical effect of allowing autoregressive token generation at the machine learning model to be selectively replaced with database lookup operations.

According to this aspect, the one or more processing devices may be further configured to assign respective output token metadata to the output tokens. The output token metadata of each output token may indicate the primary machine learning model or the one or more drafting models with which that output token was generated. The one or more processing devices may be further configured to present the output to a user at a graphical user interface (GUI) along with a graphical representation of the output token metadata. The above features may have the technical effect of displaying the provenance of different portions of the output.

According to this aspect, the one or more processing devices are further configured to compute the first portion at a plurality of drafting models. At the selective speculative decoding logic, during generation of the first portion, the one or more processing devices may be further configured to modify a number of drafting models with which the first portion is computed. The above features may have the technical effect of adding or removing drafting models according to properties of the output such as estimated complexity.

According to this aspect, the one or more processing devices may be further configured to receive a speculative decoding selection user input that indicates one or more speculative decoding activation rules associated with the prompt. At the selective speculative decoding logic, the one or more processing devices may be further configured to select the first portion and the second portion at least in part by applying the one or more speculative decoding activation rules. The above features may have the technical effect of allowing the user to specify at least a portion of the selective speculative decoding logic in a prompt-specific manner.

According to another aspect of the present disclosure, a method for use with a computing system is provided. The method includes receiving a prompt. The method further includes tokenizing the prompt to obtain a tokenized prompt including a plurality of input tokens. Based at least in part on the input tokens, the method further includes computing an output including a plurality of output tokens over a plurality of autoregressive generation iterations. Computing the output includes, in one or more of the autoregressive generation iterations, based at least in part on a context including the tokenized prompt and a prior output token sequence, executing selective speculative decoding logic to select a first portion and a second portion of the output. Computing the output further includes computing the first portion of the output via speculative decoding using one or more drafting models. Computing the output further includes computing the second portion of the output at a primary machine learning model without using speculative decoding. The method further includes transmitting the output to an additional computing process. The above features may have the technical effect of generating the output in a manner that uses speculative decoding to reduce latency, while also avoiding computational costs associated with executing the drafting models when generating portions of the output at which the draft tokens are likely to be inaccurate.

According to this aspect, the one or more drafting models may include a plurality of drafting machine learning models that have respective drafting model parameter counts below a primary model parameter count of the primary machine learning model. The above features may have the technical effect of computing the draft tokens with lower latency and costs relative to computing output tokens at the primary machine learning model.

According to this aspect, the method may further include computing the first portion at least in part by generating respective draft tokens at a plurality of drafting models. The method may further include computing one or more similarity values between the draft tokens. The method may further include determining that the one or more similarity values are below a predefined similarity threshold. The method may further include deactivating speculative decoding in response to determining that the one or more similarity values are below the predefined similarity threshold. The above features may have the technical effect of deactivating speculative decoding when the outputs of the drafting models disagree with each other.

According to this aspect, the method may further include computing the first portion at least in part by generating respective draft tokens at the one or more drafting models. At the primary machine learning model, the method may further include performing a parallel verification check on the draft tokens. The method may further include determining that one or more of the draft tokens fail the parallel verification check. The method may further include deactivating speculative decoding in response to determining that the one or more draft tokens fail the parallel verification check. The above features may have the technical effect of checking the accuracy of the draft tokens in a low-latency manner and deactivating speculative decoding when the draft tokens disagree with the outputs of the primary machine learning model.

According to this aspect, the method may further include, at the selective speculative decoding logic, estimating an expected value of performing speculative decoding according to a predefined value function. The method may further include determining whether to use speculative decoding based at least in part on the expected value. The above features may have the technical effect of selectively activating speculative decoding when, according to the predefined value function, the expected value of using speculative decoding is positive.

According to this aspect, the method may further include executing one or more deterministic policies included among the one or more drafting models to compute the first portion. When executing the one or more deterministic policies, the method may further include performing a database lookup operation. The above features may have the technical effect of allowing autoregressive token generation at the machine learning model to be selectively replaced with database lookup operations.

According to this aspect, the method may further include assigning respective output token metadata to the output tokens. The output token metadata of each output token may indicate the primary machine learning model or the one or more drafting models with which that output token was generated. The method may further include presenting the output to a user at a graphical user interface (GUI) along with a graphical representation of the output token metadata. The above features may have the technical effect of displaying the provenance of different portions of the output.

According to this aspect, the method may further include computing the first portion at a plurality of drafting models. The method may further include, at the selective speculative decoding logic, during generation of the first portion, modifying a number of drafting models with which the first portion is computed. The above features may have the technical effect of adding or removing drafting models according to properties of the output such as estimated complexity.

According to this aspect, the method may further include receiving a speculative decoding selection user input that indicates one or more speculative decoding activation rules associated with the prompt. At the selective speculative decoding logic, the method may further include selecting the first portion and the second portion at least in part by applying the one or more speculative decoding activation rules. The above features may have the technical effect of allowing the user to specify at least a portion of the selective speculative decoding logic in a prompt-specific manner.

According to another aspect of the present disclosure, a computing system is provided, including one or more processing devices configured to receive a prompt. The one or more processing devices are further configured to tokenize the prompt to obtain a tokenized prompt including a plurality of input tokens. Based at least in part on the input tokens, the one or more processing devices are further configured to compute an output including a plurality of output tokens over a plurality of autoregressive generation iterations. Computing the output includes, in one or more of the autoregressive generation iterations, based at least in part on a context including the tokenized prompt and a prior output token sequence, executing selective speculative decoding logic to select a first portion and a second portion of the output. Computing the output further includes computing the first portion of the output via speculative decoding using a set of one or more drafting models. At the selective speculative decoding logic, the one or more processing devices are further configured to modify the set of one or more drafting models used to generate the first portion during the generation of the output. Computing the output further includes computing the second portion of the output at a primary machine learning model without using speculative decoding. The one or more processing devices are further configured to assign respective output token metadata to the output tokens. The output token metadata of each output token indicates the primary machine learning model or the one or more drafting models with which that output token was generated. The one or more processing devices are further configured to transmit the output for display at a graphical user interface (GUI) along with a graphical representation of the output token metadata. The above features may have the technical effect of generating the output in a manner that uses speculative decoding to reduce latency, while also avoiding computational costs associated with executing the drafting models when generating portions of the output at which the draft tokens are likely to be inaccurate.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
one or more processing devices configured to:
receive a prompt;
tokenize the prompt to obtain a tokenized prompt including a plurality of input tokens;
based at least in part on the input tokens, compute an output including a plurality of output tokens over a plurality of autoregressive generation iterations, wherein computing the output includes:
in one or more of the autoregressive generation iterations, based at least in part on a context including the tokenized prompt and a prior output token sequence, executing selective speculative decoding logic to select a first portion and a second portion of the output;
computing the first portion of the output via speculative decoding using one or more drafting models; and
computing the second portion of the output at a primary machine learning model without using speculative decoding; and
transmit the output to an additional computing process.

2. The computing system of claim 1, wherein the one or more drafting models include a plurality of drafting machine learning models that have respective drafting model parameter counts below a primary model parameter count of the primary machine learning model.

3. The computing system of claim 1, wherein the one or more processing devices are further configured to:
compute the first portion at least in part by generating respective draft tokens at a plurality of drafting models;
compute one or more similarity values between the draft tokens;
determine that the one or more similarity values are below a predefined similarity threshold; and
deactivate speculative decoding in response to determining that the one or more similarity values are below the predefined similarity threshold.

4. The computing system of claim 1, wherein the one or more processing devices are further configured to:
compute the first portion at least in part by generating respective draft tokens at the one or more drafting models;
at the primary machine learning model, perform a parallel verification check on the draft tokens;
determine that one or more of the draft tokens fail the parallel verification check; and
deactivate speculative decoding in response to determining that the one or more draft tokens fail the parallel verification check.

5. The computing system of claim 1, wherein, at the selective speculative decoding logic, the one or more processing devices are further configured to:
estimate an expected value of performing speculative decoding according to a predefined value function; and
determine whether to use speculative decoding based at least in part on the expected value.

6. The computing system of claim 1, wherein:
the context includes a plurality of token batches; and
the one or more processing devices are configured to execute the selective speculative decoding logic for each of the token batches.

7. The computing system of claim 1, wherein:
the one or more drafting models include one or more deterministic policies; and
the one or more processing devices are configured to execute the one or more deterministic policies to compute the first portion at least in part by performing a database lookup operation.

8. The computing system of claim 1, wherein the one or more processing devices are further configured to:
assign respective output token metadata to the output tokens, wherein the output token metadata of each output token indicates the primary machine learning model or the one or more drafting models with which that output token was generated; and
present the output to a user at a graphical user interface (GUI) along with a graphical representation of the output token metadata.

9. The computing system of claim 1, wherein the one or more processing devices are further configured to:
compute the first portion at a plurality of drafting models; and
at the selective speculative decoding logic, during generation of the first portion, modify a number of drafting models with which the first portion is computed.

10. The computing system of claim 1, wherein the one or more processing devices are further configured to:
receive a speculative decoding selection user input that indicates one or more speculative decoding activation rules associated with the prompt; and
at the selective speculative decoding logic, select the first portion and the second portion at least in part by applying the one or more speculative decoding activation rules.

11. A method for use with a computing system, the method comprising:
receiving a prompt;
tokenizing the prompt to obtain a tokenized prompt including a plurality of input tokens;
based at least in part on the input tokens, computing an output including a plurality of output tokens over a plurality of autoregressive generation iterations, wherein computing the output includes:
in one or more of the autoregressive generation iterations, based at least in part on a context including the tokenized prompt and a prior output token sequence, executing selective speculative decoding logic to select a first portion and a second portion of the output;
computing the first portion of the output via speculative decoding using one or more drafting models; and
computing the second portion of the output at a primary machine learning model without using speculative decoding; and
transmitting the output to an additional computing process.

12. The method of claim 11, wherein the one or more drafting models include a plurality of drafting machine learning models that have respective drafting model parameter counts below a primary model parameter count of the primary machine learning model.

13. The method of claim 11, further comprising;
computing the first portion at least in part by generating respective draft tokens at a plurality of drafting models;
computing one or more similarity values between the draft tokens;
determining that the one or more similarity values are below a predefined similarity threshold; and
deactivating speculative decoding in response to determining that the one or more similarity values are below the predefined similarity threshold.

14. The method of claim 11, further comprising:
computing the first portion at least in part by generating respective draft tokens at the one or more drafting models;
at the primary machine learning model, performing a parallel verification check on the draft tokens;
determining that one or more of the draft tokens fail the parallel verification check; and
deactivating speculative decoding in response to determining that the one or more draft tokens fail the parallel verification check.

15. The method of claim 11, further comprising, at the selective speculative decoding logic:
estimating an expected value of performing speculative decoding according to a predefined value function; and
determining whether to use speculative decoding based at least in part on the expected value.

16. The method of claim 11, further comprising:
executing one or more deterministic policies included among the one or more drafting models to compute the first portion; and
when executing the one or more deterministic policies, performing a database lookup operation.

17. The method of claim 11, further comprising:
assigning respective output token metadata to the output tokens, wherein the output token metadata of each output token indicates the primary machine learning model or the one or more drafting models with which that output token was generated; and
presenting the output to a user at a graphical user interface (GUI) along with a graphical representation of the output token metadata.

18. The method of claim 11, further comprising:
computing the first portion at a plurality of drafting models; and
at the selective speculative decoding logic, during generation of the first portion, modifying a number of drafting models with which the first portion is computed.

19. The method of claim 11, further comprising:
receiving a speculative decoding selection user input that indicates one or more speculative decoding activation rules associated with the prompt; and
at the selective speculative decoding logic, selecting the first portion and the second portion at least in part by applying the one or more speculative decoding activation rules.

20. A computing system comprising:
one or more processing devices configured to:
receive a prompt;
tokenize the prompt to obtain a tokenized prompt including a plurality of input tokens;
based at least in part on the input tokens, compute an output including a plurality of output tokens over a plurality of autoregressive generation iterations, wherein computing the output includes:
in one or more of the autoregressive generation iterations, based at least in part on a context including the tokenized prompt and a prior output token sequence, executing selective speculative decoding logic to select a first portion and a second portion of the output;
computing the first portion of the output via speculative decoding using a set of one or more drafting models,
wherein, at the selective speculative decoding logic, the one or more processing devices are further configured to modify the set of one or more drafting models used to generate the first portion during the generation of the output; and
computing the second portion of the output at a primary machine learning model without using speculative decoding;
assign respective output token metadata to the output tokens, wherein the output token metadata of each output token indicates the primary machine learning model or the one or more drafting models with which that output token was generated; and
transmit the output for display at a graphical user interface (GUI) along with a graphical representation of the output token metadata.
